(19) United States
(12) Patent Application Publication
(10) Pub. No.: US 2010/0014868 A1
(43) Pub. Date: Jan. 21, 2010

(54) Hybrid optical/wireless RF transceiver modules and photonic network components

(75) Inventors: Daniel McGlynn, Albuquerque, NM (US); Clay E. Hudgins, Edgewood, NM (US)

Correspondence Address: EMCORE CORPORATION, 1600 EUBANK BLVD, S.E., ALBUQUERQUE, NM, 87123, US

(73) Assignee: Emcore Corporation, Albuquerque, NM (US)

(21) Appl. No.: 12/218,940

(22) Filed: Jul. 18, 2008

(51) Int. Cl. H04B 10/00

(52) U.S. Cl. 398/115

(57) ABSTRACT

A data communications system including a passive optical network; an optical network termination unit connected to the network including a first optical receiver for voice and data on a 1480-1500 mm band to an end-user; an optical transmitter transmitting voice and data optical signals on a 1260-1360 mm band from the end-user, and a second optical receiver for receiving a digital video signal on a 1550 mm band from a video head-end service provider to the end-user; and a wireless RF communications transmitter coupled to at least the second optical receiver for wirelessly transferring the information content of the optical signal to an external device.

### REFERENCE TO RELATED APPLICATIONS

This application is related to U.S. patent application Ser. No. 11/712,725 filed Mar. 1, 2007, and U.S. patent application Ser. No. 11/620,317 filed Jan. 5, 2007, both herein incorporated by reference and assigned to the common assignee.

### BACKGROUND OF THE INVENTION

1. Field of the Invention

The invention relates to “photonics” or optical communications devices, such as optical transmitters, receivers, and transceivers used in high throughput fiber optic communications links in local and wide area networks and storage networks, and in particular to a wireless RF communications transmitter and interface format associated with such devices, for high bandwidth content delivery to a user device at a subscriber premises, such as HD video data streaming to large, high definition flat panel displays.

2. Description of the Related Art

Communications networks have experienced dramatic growth in data transmission traffic in recent years due to worldwide Internet access, e-mail, and e-commerce. As Internet usage grows to include transmission of larger data files, including content such as full motion video on-demand (including HDTV), multi-channel high quality audio, online video conferencing, image transfer, and other broadband applications, the delivery of such data will place a greater demand on available bandwidth. The bulk of this traffic is already routed through the optical networking infrastructure used by local and long distance carriers, as well as Internet service providers. Since optical fiber offers substantially greater bandwidth capacity, is less error prone, and is easier to administer than conventional copper wire technologies, it is not surprising to see increased deployment of optical fiber in data centers, storage area networks, and enterprise computer networks for short range network unit to network unit interconnection, and more recently to the home and commercial establishments for delivery of high quality video content.

Fiber optic technology has been recognized for its high bandwidth capacity over longer distances, enhanced overall network reliability and service quality. Fiber to the premises (“FTTP”), as opposed to fiber to the node (“FTTN”) or fiber to the curb (“FTTC”) delivery, enables service providers to deliver substantial bandwidth and a wide range of applications directly to business and residential subscribers. For example, FTTP can accommodate the so-called “triple-play” bundle of services, e.g., high-speed Internet access and networking, multiple telephone lines and high-definition and interactive video applications.

Utilizing FTTP, however, involves equipping each subscriber premises with the ability to receive an optical signal and convert it into a signal compatible with pre-existing wiring in the premises (e.g., twisted pair and coaxial). For bi-directional communication with the network, the premises should be equipped with the ability to convert outbound signals into optical signals. In some cases, these abilities are implemented with a passive optical network (“PON”), with each premise having a dedicated optical network unit (“ONU”) for transcribing optical and electrical signals. In some instances, the ONU for a given subscriber is mounted outdoors on the subscriber's building, or may be situated indoors in a rack or cabinet.

Generally speaking, a PON is a point-to-multipoint fiber to the premises network architecture in which unpowered optical splitters are used to enable a single optical fiber to serve multiple (e.g., 32) premises. A PON can include an optical line termination (“OLT”) at the service provider's central office and a PON module for each end user. Some currently implemented PONs employ the ITU-T G.983 standard, sometimes called “BPON” or “broadband PON.” BPON includes support for wavelength division multiplexing, dynamic and higher upstream bandwidth allocation, and survivability. It also includes a standard management interface, called OMCI, between the OLT and PON module, enabling mixed-vendor networks. BPON supports bit rates of about 622 Mbits/second downstream and about 155 Mbits/second upstream. The next generation standard is ITU-T G.984, sometimes called “GPON” or “gigabit PON.” Compared to BPON, GPON supports higher rates (2,488 Mbits/second downstream and 1,244 Mbits/second upstream), enhanced security, and choice of Layer 2 protocol (e.g., ATM, GEM, Ethernet).

In addition to the ONU used in a PON, a variety of optical transceiver modules are also known in the art to provide such interconnection that include an optical transmit portion that converts an electrical signal into a modulated light beam that is coupled to a first optical fiber, and a receive portion that receives a second optical signal from a second optical fiber and converts it into an electrical signal, and similar implementations employ one fiber for both optical signals, traveling in opposite directions. The electrical signals are transferred in both directions over electrical connectors that interface with the network unit using a standard electrical data link protocol.

Such optical transceiver modules are typically packaged in a number of standard form factors which are “hot pluggable” into a rack mounted line card network unit or the chassis of the data system unit. Standard form factors (i.e., physical dimensions) set forth in Multiple Source Agreements (MSAs) provide standardized dimensions and input/output interfaces that allow devices from different manufacturers to be used interchangeably. Some of the most popular MSAs include XENPAK (see www.xenpak.org), X2 (see www.X2msa.org), SFF (“small form factor”), SFP (“small form factor pluggable”), XFP (“10 Gigabit Small Form Factor Pluggable”, see www.XFPMSA.org), and the 300-pin module (see www.300pinmsa.org), and the QSFP (“Quad Small Form-factor Pluggable”, see www.qsfpmsa.org).

Customers and users of such modules are interested in small or miniaturized transceivers in order to increase the number of interconnections or port density associated with the network unit, such as, for example in rack mounted line cards, switch boxes, cabling patch panels, wiring closets, and computer I/O interfaces.

A variety of different optical and electrical communication protocols are in use, such as SONET, Gigabit Ethernet, 10 Gigabit Ethernet, Fibre Channel, and SDH optical protocols, and electrical interfaces such as Infiniband, XAUI, and XIF. There are also a variety of different standards associated with high speed data communications between computer and peripheral devices.

Certain electro-optical transceiving functions are performed by a PON module (or “transceiver module”) that is disposed inside the ONU. The PON module will vary with the type of PON with which it is associated (e.g., BPON module, GPON module, etc.). In some cases, the module includes a bulk optic WDM module that separates the wavelengths of the incoming optical signal. Each of the wavelengths is then manipulated accordingly. The continuous downstream data (e.g., 1490 nm) is filtered and amplified by a limiter amplifier IC. The burst upstream data originating from the premises is converted to an optical signal (e.g., at 1310 nm) and is controlled by a burst mode laser driver IC. This IC, along with other control circuitry, controls the laser to meet the requirements of the protocol (e.g., depending on whether the network is BPON or GPON).

The downstream video broadcast streams (e.g., 1550 nm) are processed by video receiver circuitry in a “set top box” or other interface unit and transmits them through the premises via a 75-ohm coaxial cable. Normally, the interface for connecting the PON module to the coaxial cable consists of an interface cable extending from a circuit board within the PON module housing and coupling to a second circuit board at the subscriber location (e.g., within the ONU).

The increased deployment of high definition video displays, portable multimedia players, and other portable computer devices has created a potential new types of optical transceivers and transceiver modules that would enable displays and data system units such as high definition flat panel displays, and similar consumer devices to be coupled to the transceiver to provide a high speed, short reach (less than 50 meters) data link within the subscriber's premises, such as home, college dorm, commercial establishment, multi-family residence, or shopping mall.

Short-range wireless communication capability is becoming more widespread in use in a variety of different mobile devices such as portable terminals, cellular phones, personal digital assistants, pagers, MP3 players, and other mobile devices. Such devices may include short-range communication receivers or transceivers, so that the devices have the ability to communicate via RFID, Bluetooth, IEEE 803.11, IEEE 803.15, infrared or other types of short-range communication protocols dependent upon the application and type of receiver or transceiver associated with the mobile device.

Prior to the present invention, an optical transceiver or PON module has not been configured for/or provided with a wireless RF transceiver and wireless RF data communications protocols to provide high bandwidth content delivery from an optical fiber network to a portable or mobile, remotely located, subscriber device within, or closely adjacent to, the subscriber's premises.

### SUMMARY OF THE INVENTION

### 1. Objects or Aspects of Various Embodiments of the Invention

It is an aspect of the present invention in some embodiments to provide an optical transceiver with a wireless RF protocol communications interface for wireless transfer of content.

It is also another aspect of the present invention in some embodiments to provide a pluggable module for use in an optical fiber transmission system with a wireless RF transmitter for downloading high bandwidth content such as streaming video to a subscriber device.

It is also another aspect of the present invention in some embodiments to provide a PON module with a wireless RF communications transceiver for wireless transfer of content.

It is also another aspect of the present invention in some embodiments to provide a hybrid fiber optical network and a wireless LAN network for downloading high bandwidth content such as streaming video to a portable or mobile subscriber device on the wireless LAN network.

It is also another aspect of the present invention in some embodiments to provide an optical network termination unit in a passive optical network with an optical fiber communications interface for transfer of high bandwidth content to a subscriber device.

It is also another aspect of the present invention in some embodiments to provide a module for use in an FTTx optical fiber transmission system that functions as a gateway for telephone, Ethernet, coaxial cable, and wireless LAN connectivity at a subscriber's premises.

### 2. Features of the Invention

Briefly, and in general terms, the present invention provides an optical network unit or optoelectronic module including a housing having an interface coupling to an external optic fiber for receiving an optical signal representing certain information content; an electro-optic subassembly disposed in the housing for converting the optical signal to an electrical signal corresponding to the information content, and a wireless RF transmitter disposed in the housing for transmitting the information content to an external device.

In another aspect the present invention provides a passive optical network terminal unit including a first optical receiver for receiving encoded voice and data optical signals on a 1480-1500 mm band to an end-user; an optical transmitter for transmitting voice and data optical signals on a 1260-1360 mm band from the end-user; and a second optical receiver for receiving a digital video signal on a 1550 mm band from a video head-end service provider to the end-user; and a wireless RF communication transmitter disposed in the unit and coupled to one or more of the electro-optic subassemblies for wirelessly transferring the information content of the optical signals to an external device.

4. In still another aspect, the present invention provides a data communications system comprising: a passive optical network; an optical network termination unit connected to said network including a passive optical network terminal unit including a first optical receiver for voice and data on a 1480-1500 mm band to an end-user; an optical transmitter for transmitting voice and data optical signals on a 1260-1360 mm band from the end-user, and a second optical receiver for receiving a digital video signal on a 1550 mm wavelength band from a video head-end service provider to the end-user; a wireless RF communications transmitter disposed in the housing of the unit and coupled to one or more of the electro-optic subassemblies for wirelessly transferring the information content of the optical signals to an external device.

Additional objects, advantages, and novel features of the present invention will become apparent to those skilled in the art form this disclosure, including the following detailed description as well as by practice of the invention. While the invention is described below with reference to preferred embodiments, it should be understood that the invention is not limited thereto. Those of ordinary skill in the art having access to the teachings herein will recognize additional applications, modifications and embodiments in other fields, which are within the scope of the invention as disclosed and claimed herein and with respect to which the invention could be of utility.

### BRIEF DESCRIPTION OF THE DRAWINGS

These and other features and advantages of this invention will be better understood and more fully appreciated by reference to the following detailed description when considered in conjunction with the accompanying drawings, wherein:

FIG. 1 is a block diagram illustrating an implementation of a PON (e.g., GPON) network architecture;

FIG. 2A is a block diagram of an implementation of a transceiver module for use in a PON network as is known in the prior art;

FIG. 2B is a block diagram of an implementation of a transceiver module for use in a PON network according to a first embodiment of the present invention;

FIG. 2C is a block diagram of an implementation of a transceiver module for use in a PON network according to a second embodiment of the present invention;

FIG. 3 is a highly simplified block diagram of certain elements of a subscriber a remote terminal which communicates with the transceiver module over a wireless LAN;

FIG. 4 is a top plan view of a display on a subscriber device used in the initialization phase of an embodiment of the present invention;

FIG. 5 is a highly simplified diagram of a computer network in which the present invention may be employed;

FIG. 6 is a flow chart depicting the initialization or encoding of identification (PIN) and other data in the module during manufacture;

FIG. 7 is a flow chart depicting setting the operational parameters for video transmission and display using a portable computer terminal;

FIG. 8 is a flow chart depicting the determination of association, authentication and authorization of the wireless RF link to the remote display terminal; and

FIG. 9 is a flow chart depicting the adjustment and specification of certain display formatting and link parameters of the RF wireless link according to the present invention.

Additional objects, advantages, and novel features of the present invention will become apparent to those skilled in the art from this disclosure, including the following detailed description as well as by practice of the invention. While the invention is described below with reference to preferred embodiments, it should be understood that the invention is not limited thereto. Those of ordinary skill in the art having access to the teachings herein will recognize additional applications, modifications and embodiments in other fields, which are within the scope of the invention as disclosed and claimed herein and with respect to which the invention could be of utility.

### DESCRIPTION OF THE PREFERRED EMBODIMENT

Details of the present invention will now be described including exemplary aspects and embodiments thereof. Referring to the drawings and the following description, like reference numbers are used to identify like or functionally similar elements, and are intended to illustrate major features of exemplary embodiments in a highly simplified diagrammatic manner. Moreover, the drawings are not intended to depict every feature of the actual embodiment nor the relative dimensions of the depicted elements, and are not drawn to scale.

I. Network Architecture

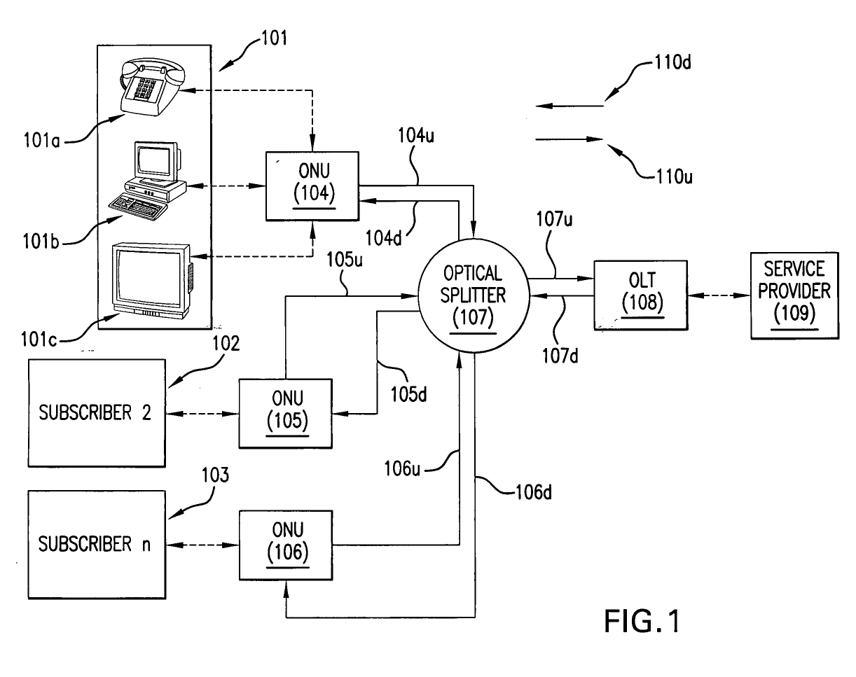

FIG. 1 illustrates an implementation of a network topology associated with a passive optical network, e.g., a GPON. Data transmission in the direction of arrow 110d will be referred to as “downstream” and data transmission in the direction of arrow 110u will be referred to as “upstream.” Solid lines represent data exchange via an optical link (e.g., one or more fiber optic cables or fibers) and dotted lines represent data exchange via a non-optical link (e.g., one or more copper or other electrically conductive cables). Data transmission via optical links can be bi-directional, even over single fibers. Accordingly, in some implementations, subscribers (e.g., 101-103) receive and transmit data over a single fiber optic cable.

Service provider 109 provides one or more data services to a group of subscribers (e.g., 101-103). In some case, the data services include, for example, television, telephone (e.g., voice over IP or “voIP) and internet connectivity. In some implementations, broadcast television (IPTV) or interactive television services may be provided to accommodate features such as selection of channels or “on-demand” viewing of content. The service provider 109 may generate some or all of the content that the subscribers receive, or it may receive some or all of the content from third parties via a data link. For example, the service provider 109 can provide Internet connectivity by coupling to the Internet via a Gigabit Ethernet connection or E1 or T1 connection(s). Also, the service provider 109 may couple to the PSTN for telephone service, e.g., via E1 or T1 connection(s). The service provider 109 can receive certain television content, e.g., via satellite. Television content can include additional data that is generated or provided by the service provider 109, e.g., data regarding programming schedules.

The service provider 109, as part of providing data services to a group of subscribers, can be adapted to receive data from subscribers. For television services, the service provider 109 receives data from subscribers indicative of, e.g., purchases and/or selection of “on-demand” type material or changes to subscription parameters (e.g., adding or deleting certain services). For telephone and Internet services, the service provider 109 receives data originating from subscribers, thereby enabling bi-directional communication such as through upstream tiem allocated windows over the optical fiber.

The service provider 109 is adapted to provide the data services content (e.g., bi-directional telephone, television and Internet content via a non-optical link to an optical line termination unit (“OLT”) 108. The link between OLT 108 and service provider 109 can consist of one or more copper or other electrically conductive cables. The OLT 108 is adapted to receive data from the service provider 109 in one format (e.g., electrical) and convert to an optical format. The OLT 108 is further adapted to receive data from subscribers (e.g., 101-103) in an optical format and convert it to another format (e.g. electrical) for transmission to the service provider 109. In this implementation, the OLT 108 may be analogized to an electro-optical transceiver that: (1) receives upstream data in an optical format from subscribers (e.g., 107u), (2) transmits downstream data in an optical format to subscribers (e.g., 107d), (3) transmit the upstream data in electrical format to the service provider 109 and (4) receives the downstream data from the service provider in an electrical format.

To transmit the various data from the service provider 109 (e.g., telephone, television and internet) on as few optical fibers as possible, the OLT 108 performs multiplexing. In some implementations, the OLT 108 generates two or more optical signals representative of the data from the service provider 109. Each signal has a different wavelength (e.g., 1490 nm for continuous downstream data and 1550 nm for continuous downstream video) and is transmitted along a single fiber. This technique is sometimes referred to as “wavelength division multiplexing.” Also, as certain data from the service provider 109 may be destined for only a particular subscriber (e.g., downstream voice data for a particular subscriber's telephone call, the downstream data for a particular subscriber's internet connection or the particular “on demand” video content requested by a particular subscriber), some implementations of the OLT 108 employ time division multiplexing (“TDM). TDM allows the service provider 109 to target content delivery to a particular subscriber (e.g., to one or all of 101-103).

The OLT 108 is coupled to an optical splitter 107 via an optical link. The link can consist of a single optical fiber through which the OLT 108 transmits and receives optical signals (e.g., 107d and 107u, respectively). The optical splitter 107 splits the incoming optical signal (107d) from the OLT 108 into multiple, substantially identical copies of the original incoming optical signal (e.g., 104d, 105d, 106d). Depending on the implementation, each optical splitter 107 splits the incoming optical signal into 16 or more (e.g., 32 or 64) substantially identical copies. In an implementation that splits the incoming optical signal into 16 substantially identical copies, there are a maximum of 16 subscribers. Generally speaking, the number of subscriber associates with a given optical splitter is equal to or less than the number of substantially identical copies of the incoming optical signal.

In a GPON (i.e., a network compliant with ITU-T G.984), each downstream optical signal (107d) supports a downstream bandwidth of about 2,488 Mbits/second and each upstream signal (107u) supports an upstream bandwidth of about 1,244 Mbits/second.

In this implementation, the splitting is done in a passive manner (i.e., no active electronics are associates with the optical splitter 107). Each of the signals from the optical splitter 107 (e.g., 104d, 105d, 106d) is sent to a subscriber (e.g., 101-103, respectively) via an optical link.

Also, the optical splitter 107 receives data from subscribers via optical links. The optical splitter 107 combines (e.g., multiplexes) the optical signals (104u, 105u, 106u) from the multiple optical links into a single upstream optical signal (107u) that is transmitted to the OLT 108. In some implementations, each subscriber is equipped with an ONU that employs time division multiple access (TDMA). This allows the service provider 109, with appropriate demultiplexing, to identify the subscriber from whom each packet of data originated.

In some implementations, upstream and downstream data between a subscriber (e.g., one of 101-103) and the optical splitter 107 is transmitted bi-directionally over a single fiber optic cable.

The optical splitter 108 typically is disposed in a location remote from the service provider. For example, in a PON implemented for subscribers in a residential area, a given neighborhood will have an associated optical splitter 107 that is coupled, via the OLT 108, to the service provider 109. In a given PON, there can be many optical splitters 107, each coupled to an OLT 108 via an optical link. Multiple optical splitters 107 can be coupled to a single OLT 108. Some implementations employ more than one OLT and/or service provider.

The optical splitter 107 provides the substantially identical downstream signals (104d, 105d, and 106d) to optical network units (104, 105, and 106, respectively) associated with subscribers (101, 102, and 103, respectively). In some implementations, each respective PON module is disposed in the vicinity of the subscriber's location. For example, an ONU may be disposed outside a subscriber's home (e.g., near other utility connections).

In the context of the network architecture, each ONU operates in a substantially identical fashion. Accordingly, only the functionality of ONU 104 will be discussed in detail.

ONU 104 receives the downstream signal 104d and demultiplexes it into its constituent optical signals. These constituent optical signals are converted to corresponding electrical signals (according to a protocol) and transmitted via electrical links to the appropriate hardware. In some implementations, electrical signals are generated that correspond to telephone (including either twisted pair, CAT5 or Ethernet VoIP), data/internet and television service. For example, electrical signals corresponding to telephone service are coupled to traditional telephone wiring at the subscriber's location, which ultimately connects with the subscriber's phone 101a. Data/internet services (e.g., for a PC 101b) also may be provided via traditional telephone wiring or Ethernet cable. Television signals (e.g., for a cable-compatible television 101c) are converted to appropriate RF signals and transmitted on coaxial cable installed at a subscriber's location.

As telephone, internet/data and television services all can be bi-directional, the ONU also receives electrical signals that correspond to data originating from the subscriber location. This upstream data is converted to an optical signal 104u by the ONU 104 (according to a protocol) and transmitted to the optical splitter 107. The optical splitter 107 combines optical signal 104u with the optical signals from other ONUs (e.g., 105u and 106u) for transmittal to the OLT 108 (as signal 107u).

II. Implementations of a PON Module

Generally speaking, an ONU includes a PON module that (1) receives a multiplexed optical signal from an optical splitter and demultiplexes it into two or more distinct optical signals that are converted into respective electrical signals and (2) receives distinct electrical signals that are converted into respective optical signals which are multiplexed for transmission. In PON modules used in connection with GPONs, the transmission and receipt of optical signals is governed by an ITU-T G.984-compliant protocol.

The electrical signals are commonly associated with implementing services for the subscriber, e.g., data/Internet, telephone and television. To maintain signal integrity, it is desirable to keep crosstalk between the incoming video, incoming DTA and outgoing data signals to a minimum. This is coming increasingly difficult given the miniaturization of the PON module and the high-frequency characteristics of the electrical signals. Also, given that ONUs are often mounted outdoors, it is desirable to maintain signal integrity regardless of ambient temperature.

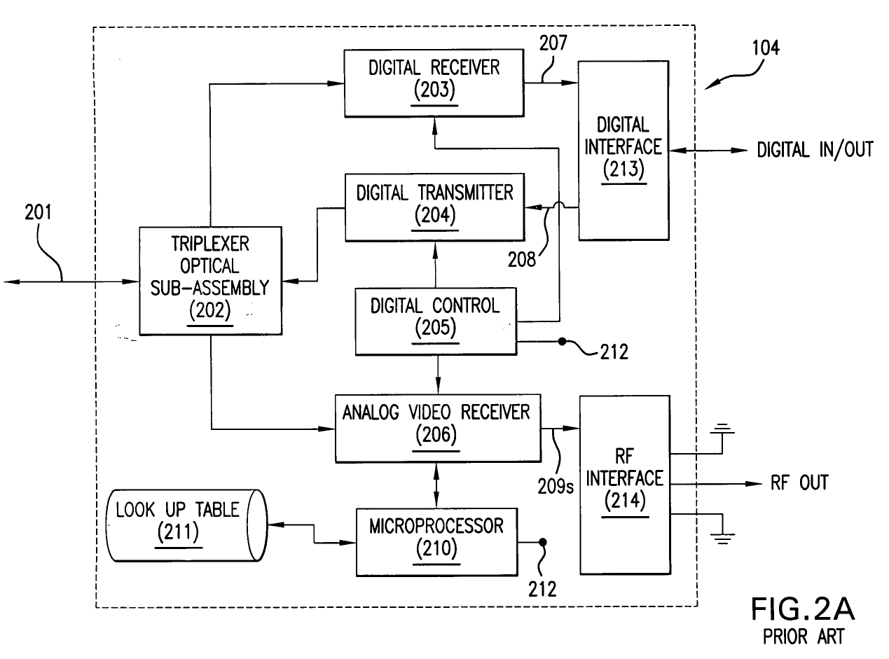

FIG. 2A illustrates a schematic of an implementation of a GPON module 220 that is disposed inside an ONU (e.g., item 104 of FIG. 1) as is known in the prior art. The module 220 comprises a triplexer optical sub-assembly 202 which is coupled to optical fiber 201. The optical fiber 201 carries an upstream optical signal (e.g. item 104u of FIG. 1) from the optical splitter (e.g., item 107 of FIG. 1) and carries a downstream optical signal (e.g., item 104d of FIG. 1) to the optical splitter. Optical fiber 201 can couple to several additional optical fibers before ultimately reaching an optical splitter. The triplexer 202 can take the form of a package electro-optical transceiver, and comprises one optical input/output port (coupled to optical fiber 201), two electrical outputs (one for data and one for video) and one electrical input (for upstream data).

In the illustrated implementation, the triplexer demultiplexes the downstream optical signal into two constituent optical signals. The constituent optical signals are converted into electrical signals, e.g., by photodiodes. The electrical signal corresponding to downstream data (e.g., from the 1490 nm optical signal) is transmitted to a digital receiver 203. The digital receiver 203, under control of digital control 205, provides an electrical data output signal 207. The digital control 205 ensures that the electrical signal 207 properly corresponds to the 1490 nm downstream optical signal according to one ore more protocols. For example, in a gigabit PON (GPON), the digital control 205 ensures that all up upstream and downstream data is processed substantially in compliance with ITU-T G.984. The electrical data output signal 207 is coupled to a digital interface 213. The digital interface 213 is coupled to wiring in the subscriber's premises (e.g., via an adapter or other interface), and provides downstream data for telephone and data (e.g., via twisted-pair lines). The digital interface 213 also can transmit and receive data to/from televisions or set-top boxes (e.g., in connection with “on demand” programming).

The electrical signal corresponding to downstream video (e.g., from the 1550 nm optical signal) may have been transmitted as broadcast TV using IPTV standards or as broadband RF, and then is transmitted to an analog video receiver 206, which comprises an amplifier. Under control of digital control 205, the analog video receiver generates (and subsequently amplifies an RF electrical signal 209s. The RF electrical signal 209s is coupled to an RF interface 214. The RF interface 214 is coupled via an adapter or other interface (not shown) to television wiring in the subscriber's premises (e.g., coaxial cable).

Since video or television content may involve generating and receiving data aside from video content from analog video receiver 206 (e.g., in connection with ordering “on demand” content), the video conductors or wiring also may be coupled to the digital interface 213.

The triplexer 202 also generates an upstream, optical signal representative of data originating from the subscriber (e.g., signal 104u of FIG. 1). The digital interface 213 receives data (in an electrical format) originating from, e.g., telephones, computers, cameras and set-top boxes associated with the subscriber. This received data (208) is sent to the digital transmitter 204. The digital transmitter 204, under control of digital control 205, converts the data into a format appropriate for triplexer 202 to convert to an optical signal that is transmitted on fiber 201. The digital control ensures that the data is converted according to a predetermined protocol(s), such as SONET, Gigabit Ethernet, 10 Gigabit Ethernet, Fibre Channel and SDH optical protocols.

FIG. 2B is a highly simplified block diagram of a GPON module 250 according to a first embodiment of the present invention. In addition to the components present in the module 220, the triplex 202 features an additional interface and optical fiber input/output 251 and 252 for extending the reach of the pure optical signal from the OLT to within the subscriber's premises through the use of an optical cable to an external device such as a video display or portable computer. The fiber input/output 251, 252 connect to fiber optic connectors or receptacles 253 and 254 on the housing of the module 250.

The receptacles, 253, 254 are configured to receive fiber optic cable connectors (not shown) which mate with optical plugs associated with the cables. In the preferred embodiment, the connector receptacles 253, 254 are configured to receive industry standard LC duplex connectors. As such, mechanical keying channels are provided to ensure that the LC connectors are inserted into the receptacles 253, 254 in their correct orientation. Further, in an exemplary embodiment, the connector receptacle 253 is intended for an LC transmitter connector, and the connector receptacle 254 receives an LC receiver connector.

FIG. 2C is a highly simplified block diagram of a GPON module 260 according to a second embodiment of the present invention. In this embodiment, the digital interface 214 connects to a WLAN transceiver within the module 260. More particularly, the connection 261 interfaces to a WLAN digital processor which formats and packages the digital data into WLAN packets, and a WLAN RF processor 263 converts the digital data into an RF signal which is transmitted by antenna 264. The RF communications transmitter may be a wireless LAN transmitter using a communications protocol compliant with IEEE 802.11. The external device with which the WLAN transceiver communicates with may be selected from the group including (a) a video display; (b) a portable computer; (c) a portable telephone handset; and (d) a home security system.

Although the embodiment described above is a PON transceiver, the same principles are applicable in other types of optical transceivers suitable for operating over both multimode (MM) and single mode (SM) fiber using single or multiple laser light sources, single or multiple photodetectors, and an appropriate optical multiplexing and demultiplexing system. The design is also applicable to a single transmitter or receiver module, or a module including more than one transmitter, receiver, or transceiver adapted to communicate over different optical networks using different protocols to different service providers and satisfying a variety of different content, quality, and economic options. Reference may be made to the Related Applications, and the transceiver modules depicted therein. The housing may be selected from the group consisting of (a) an optical network terminal mounted inside a customer's premises; (b) a set-top box; (c) a wireless local area network access point; or (d) pluggable modules having form factors compliant with any of the following MSAs: (d) SFP; (e) SFP Plus; (f) XENPAK; (g) X2; (h) 300 pin.

In the depicted embodiments, the GPON module 250 and 260 are manufactured in a modular manner using separate subassemblies mounted in the housing—a transmitter subassembly, a receiver subassembly, and a protocol processing board—with each subassembly or board having dedicated functions and electrically connected to each other using either flex circuitry or mating multipin connectors, land grid arrays, or other electrical interconnect devices, the invention may also be implemented in a transceiver having a single board or subassembly mounted inside the housing.

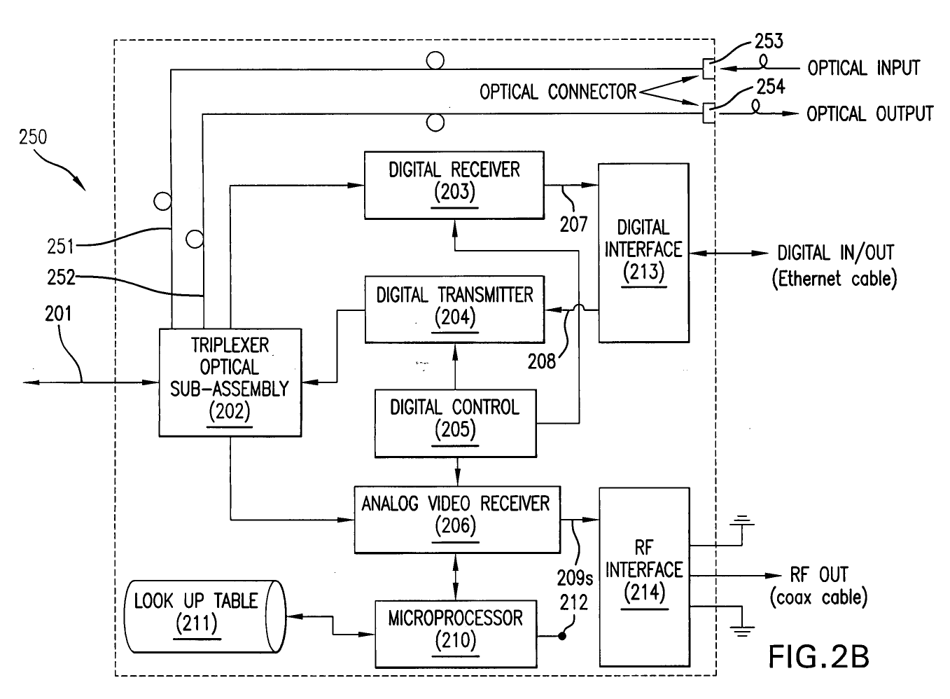

FIG. 3 is a highly simplified block diagram of certain elements of a subscriber terminal 315 which communicates with the GPON module 260 over a wireless RF link. In particular, the terminal 315 includes random access memory 301 for temporarily storing data, representing information content identity of the manufacturer and the manufacturer's serial number of the module. A PIN or cryptographic key 304 is also provided, which is utilized to verify the authorization of the subscriber and the connected wireless terminal 315 prior to the module 260 transmitting the information content, or for authorizing operational changes to be made to the communications link, as will subsequently be described.

Control software 306 is provided to coordinate operation of the various stored or adjustable items and the communications from the module 100 to the portable terminal 315. A wireless transceiver and/or receiver 307 provides means for receiving control instructions via infrared or RF communication from the WLAN transmitter 263, 264 in module 260, with a MAC address 340 being provided to the module 260.

A Media Access Control address (MAC address) is a unique identifier associated with a network adapter (NIC), such as a wireless local area network (WLAN) card plugged into a laptop computer. More particularly, it is a Level 2 address in the OSI layers. It is a number that acts like a name for the associated network adapter, and thereby the host computer associated with the adapter.

As the name implies, a MAC address is associated with the media interface which the host unit or module is utilizing for communication. Thus, a MAC address associated with a wireless interface adapter (i.e. a wireless local area network link) could be different than the Ethernet address if the same host were connected over a wired Ethernet link.

The portable terminal 315 may preferably include a display 316, keyboard or data entry buttons 317 (or touch screen display), a processor 318, memory 319, and an infrared or RF transceiver 320. Software 321 is also provided for a variety of operations and applications to be subsequently described. The terminal 315 may also include a high definition display, with the control functions being settable by an associated hand-held remote device (hereinafter the “remote”) operated by the user.

The software 321 in the terminal will allow the user to specify characteristics of the display (such as, number of lines in vertical display resolution, progressive or interlaced scanning, and number of frames per second). For example, a standard such as 1080p may be designated and specified. Compression standards, such as MPEG-2 or MPEG-4 may be specified, or uncompressed video may be specified. The user can enter such characteristics by keypad in the terminal and such commands then wirelessly communicated to the module 260. The use may also enter operational changes like change of channel, change of service provider, screen size, communications protocol, packet control fields, encoding (e.g. 8B/10B), etc.

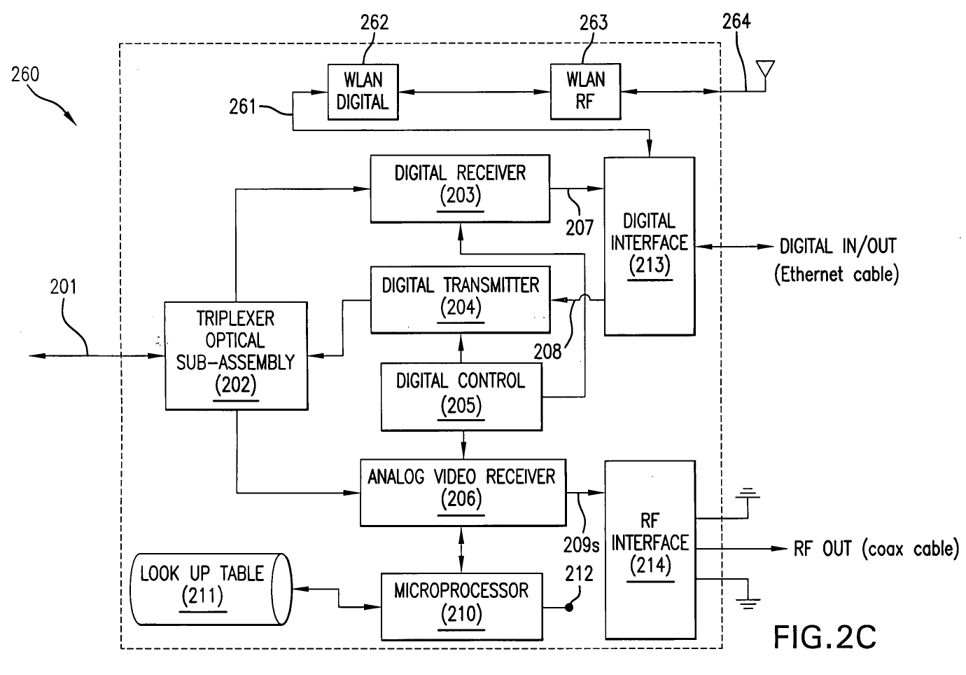

FIG. 4 is a top plan view of an embodiment of a handheld or portable terminal 315 with a display 316 depicting the various parameters and data that may be entered or selected by a user in real time, as well as for checking on the operational status and condition of the wireless data link associated with a module 260.

In particular, FIG. 4 depicts a housing with a variety of buttons 317, a scroll button 325, used to adjust the display. An example of the type of data that may be displayed and entered or selected by the user when the portable terminal 315 is in communications range with modules 260 includes selection and identification of the service provider 326, identification of the class of service 327, identification of the subscriber (e.g. by customer identification number) 328, authentication of the customer (by PIN or other code) 329, identification of the subscriber device number 330, identification of the subscriber device type (e.g., cell phone, portable digital assistant, portable computer, monitor, large screen display, etc.) 331, the compression level (i.e. uncompressed, MPEG 2, MPEG 4, etc.) 332, and the designation of the number of pixels or other display standard (e.g. VGA, SVGA, XA, SXGA, UXGA, QXGA, HDTV). Moreover, the characteristics or protocols or other standards pertaining to the audio channels may be identified and selected at 334, and other user defined features identified and selected at 335.

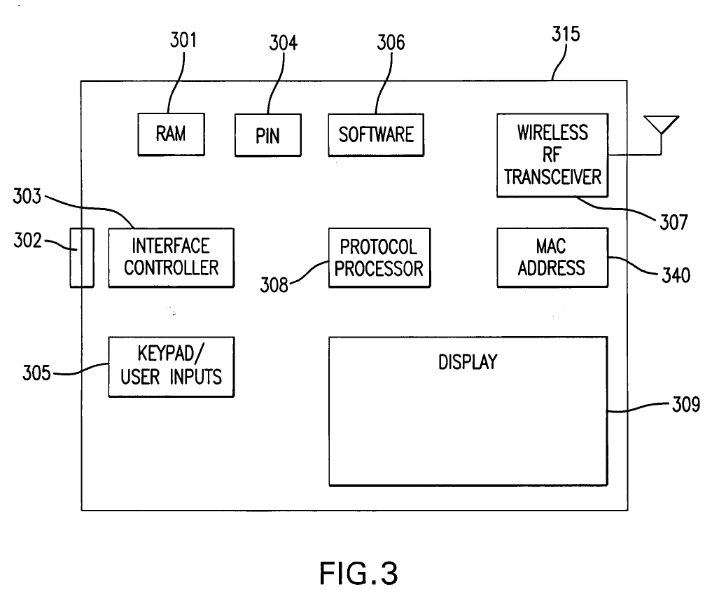

FIG. 5 shows a computer or data communications network as might be employed in multi-site enterprise information systems, and a possible typical configuration or interconnection between a plurality of modules 100 associated with different hosts, several hosts 310 (identified as Host-A, Host-B, and Host-C, a portable or mobile terminal 315, and an authentication server 406. In some instances, the modules 100 may be on the same private network 401 as the authentication server 406. In other cases, the modules 100 may connect directly to the public network 402, such as the Internet. An Ethernet LAN 500 is associated with Host-A 310, including an access point 501.

Similarly, the authentication server may connect to the Internet 402 or one or more private networks 401, 403. When a module 100 and authentication server are on separate private networks, these private networks may be connected directly together by network equipment (bridge, router, or switch) 405.

Alternately, when the module 100 and authentication server 406 are on separate private networks 401, 403, these private networks may first connect to the Internet 402 via network equipment 404, 405 in order to form the necessary end-to-end connectivity between the module 100 and the authentication server 406.

Moreover, a plurality of authentication servers 406 may be distributed around the network for improved fault tolerance and/or improved speed of access. In the case of a plurality of authentication servers 406, these authentication servers will periodically synchronize their databases among themselves.

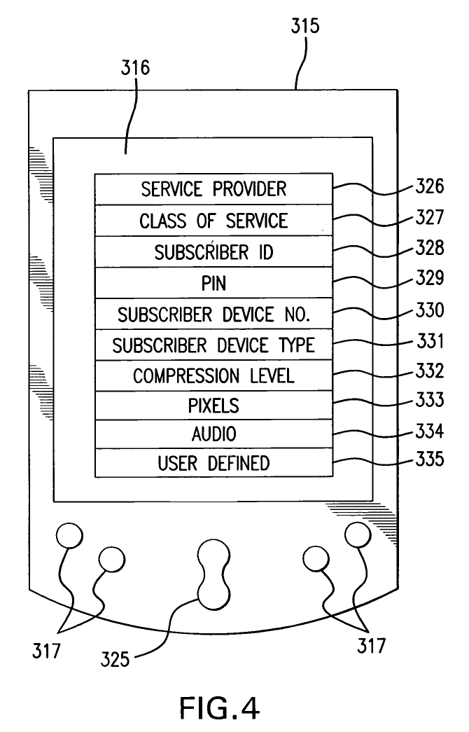

FIG. 6 is a flow chart depicting the initialization of encoding of the PON transceiver 260, or handheld or portable terminal 315 during manufacture; in particular, at step 601, the module is plugged into a test or initialization unit, powered and configured to receive identification and security data; at step 602 the PIN or cryptographic key 603 is externally generated and written into the module, after which the module is removed 603 from the programming setup unit. In addition to including information on the specific customer or class of customer equipment for which the module is authorized to be operative with, the key may cryptographically encrypt the serial number or other manufacturer's data with a digital signature or watermark.

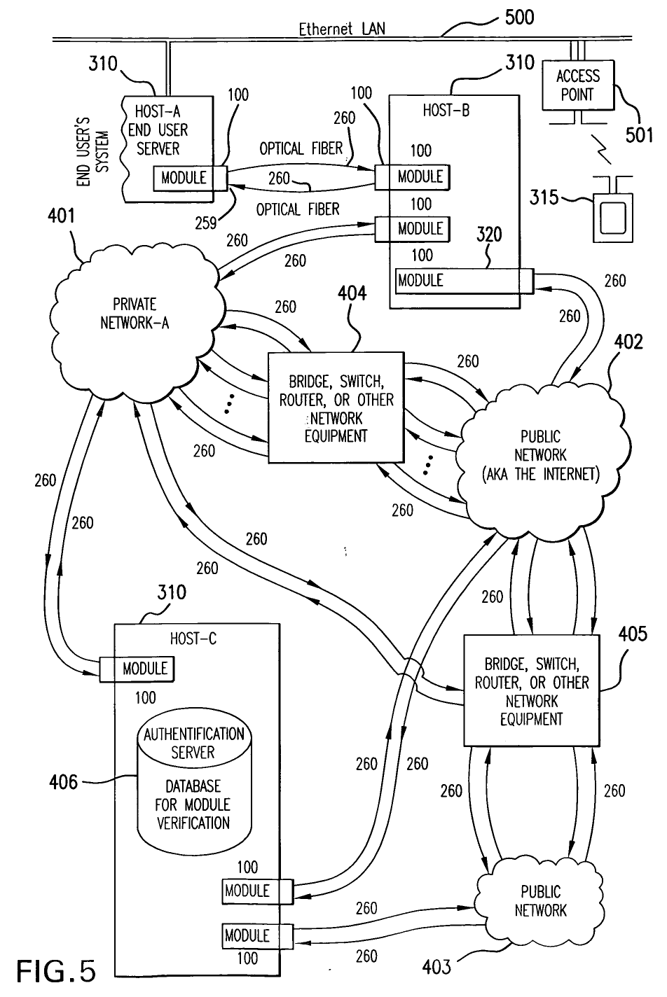

FIG. 7 depicts one aspect of the present invention by a flow chart of the initialization phase of the wireless local area connection established between the optical module 260 and the remote unit or display 315. Once a downloaded actuation signal is received by the optical module, the module automatically turns on its wireless RF receiver to receive beacon signals from the wireless networks within range of the module, and assembles a list of such networks, at step 701. Alternatively, the optical module may be initialized by the user manually through a button on the unit itself, or through a signal from wired electrical connection from a remote activation point at the user's location. From the list of available networks, the optical module elects the desired network from predetermined stored network identification criteria, at step 702. Alternatively, a user may override the preselected networks, and manually designate a network (such as through the graphical user interface in portable terminal 315 depicted in FIG. 4), or through an electrical control signal through a wired electrical connection.

Once the appropriate network has been selected, the wireless transmitter in the optical module 260 communicates with the portable terminal 315, and executes the usual association/authentication and authorization software routines, at step 703, to ensure to both the optical module 260 and the terminal 315 that both units are legitimate and appropriately authorized to establish and maintain the communications link to the terminal 315, and to the receiver end point, such as an HDTV display for displaying the video content transmitted over the passive optical network. The class or quality of service (QoS) and other link parameters may be appropriately set depending at step 704,

Finally, once the link between the module 260 and the terminal 315 has been appropriately established, a “ready” signal may be sent upstream in the passive optical network to commence the streaming video or other data content to the module 260, and then to the receiver or end terminal unit 315.

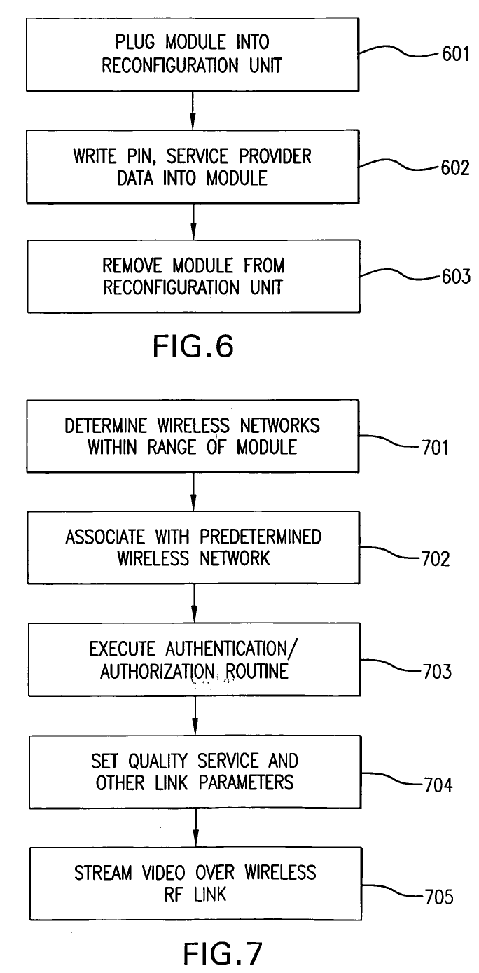

Another aspect of the present invention is set forth in the flow chart of FIG. 8, where at step 801, association, authentication, and authorization is completed, and link data (such as received signal strength, signal to noise ratio, etc.) is acquired in the module 260 from the remote 315 unit. At step 802, the required wireless RF and optical interfaces are determined in the module 260 based upon the parameters selected in step 704 above. The data rate and other operational parameters. Step 803 illustrates a variety of possible operations by the module 260 in this embodiment including adapting the PGS.PMA board's functional parameters to the electrical and optical protocols need for the desired link and display characteristics specified by the user as described in connection with FIG. 4.

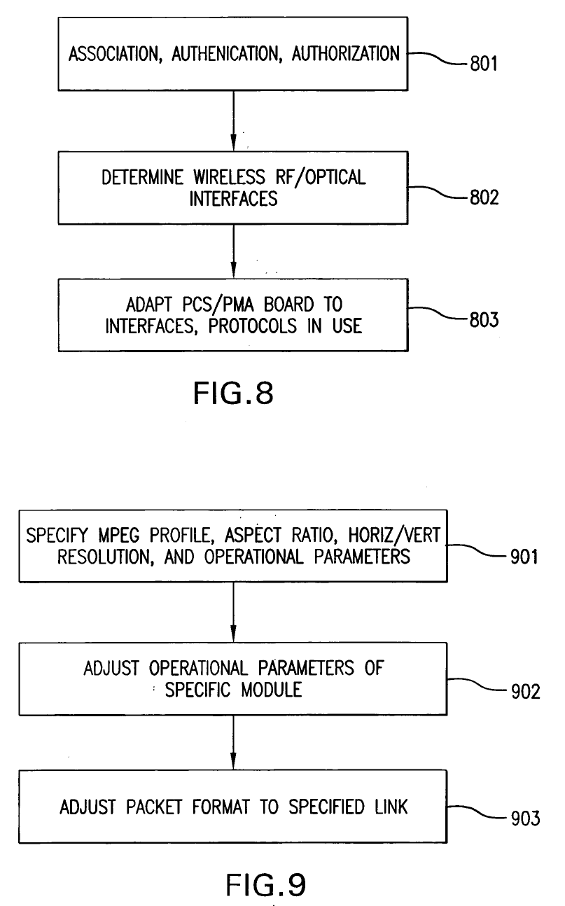

Another feature of the invention is set forth in the flow chart of FIG. 9, which describes another aspect of the present invention. At step 901, operational parameters (such as the parameters described in connection with FIG. 4) are specified by the user. At step 902, the operational parameters are used in the module 260 to set the operational parameters. At step 903, the transmission packets are formatted according to a format appropriate for the quality of service as specified by the user.

Various aspects of the techniques and apparatus of the present invention may be implemented in digital circuitry, or in computer hardware, firmware, software, or in combinations or them. Circuits of the invention may be implemented in computer products tangibly embodied in a machine-readable storage device for execution by a programmable processor, or on software located at a network node or web site which may be downloaded to the computer product automatically or on demand. The foregoing techniques may be performed by, for example, a single central processor, a multiprocessor, one or more digital signal processors, gate arrays of logic gates, or hardwired logic circuits for executing a sequence of signals or program of instructions to perform function s of the invention by operating on input data and generating output. The methods may advantageously be implemented in one or more computer programs that are executable on a programmable system including at least one programmable processor coupled to receive data and instructions from, and to transmit data and instructions to, a data storage system at least one in/out device, and at least one output device. Each computer program may be implemented in a high-level procedural or object-oriented programming language, or in assembly or machine language if desired; and in any case, the language may be compiled of interpreted language. Suitable processors include, by way of example, both general and special purpose microprocessors. Generally, a processor will receive instructions and data from read-only memory and/or random access memory. Storage devices suitable for tangibly embodying computer program instructions and data include all forms of non-volatile memory, including by way of example, semiconductor devices, such as EPROM, EEPROM, and flash memory devices; magnetic disks such as internal hard disks and removable disks; magneto-optical disks; and CD-ROM disks. Any of the foregoing may be supplemented by or incorporated in specially designed application-specific integrated circuits (ASICS).

It will be understood that each of the elements described above, or two or more together, also may find a useful application in other types of constructions differing from the types described above.

While the invention has been illustrated and described as embodied in an optical network unit, pluggable transceiver, or set-top box, among other devices, it is not intended to be limited to the details shown, since various modifications and structural changes may be made without departing in any way from the spirit of the present invention.

Without further analysis, the foregoing will so fully reveal the gist of the preset invention that others can, by applying current knowledge, readily adapt it for various applications without omitting features that, from the standpoint of prior art, fairly constitute essential characteristics of the generic of specific aspects of this invention and, therefore, such adaptations should and are intended to be comprehended within the meaning and range of equivalence of the following claims.

1. An optical network unit comprising:
a housing including a fiber optical connector adapted for coupling with an external optic fiber for receiving an information containing optical signal;
an electro-optic subassembly disposed in said housing coupled to the optical fiber for converting the optical signal to an electrical signal corresponding to the optical signals; and
a wireless RF communications transmitter disposed in said housing and coupled to said electro-optic subassembly for wirelessly transferring the information content of said optical signal to an external device.

2. An optical network unit as defined in claim 1, wherein said RF communications transmitter is a wireless LAN transmitter using a communications protocol compliant with IEEE 802.11.

3. An optical network unit as defined in claim 1, wherein said RF communications transmitter utilizes a communications technology selected from the groups of (a) ultra wide band and (b) wireless USB.

5. An optical network unit as defined in claim 1, wherein said external device is selected from the group including (a) a video display; (b) a portable computer; (c) a portable telephone handset; and (d) a home security system.

6. An optical network unit as defined in claim 1, further comprising a RF communications receiver disposed in said housing for wirelessly receiving control information from a user to select operational parameters for the wireless transfer of the information content to the external device.

7. An optical network unit as defined in claim 5, wherein said information content is streaming video data and said operational parameters are selected from a group including the compression level and display standard.

8. An optical network unit as defined in claim 6, wherein said video data is packetized as IP video.

9. An optical network unit as defined in claim 1, wherein said optical signal is transmitted using a communications transport method or protocol selected from the group consisting of (a) IPTV; and (b) broadband RF; (c) SONET; (d) Gigabit Ethernet; (e) 10 Gigabit Ethernet; (f) Fibre Channel; and (g) SDH optical protocols.

10. An optical network unit as defined in claim 1, wherein the housing is selected from the group consisting of (a) an optical network terminal mounted inside a customer's premises; (b) a set-top box; (c) a wireless local area network access point; (d) a SFP form factor; (e) a SFP Plus form factor; (f) a XENPAK form factor; (g) an X2 form factor; and (h) a 300 pin MSA form factor.

11. A passive optical network terminal unit comprising:
a first optical receiver for receiving encoded voice and data optical signals on a 1480-1500 mm band to an end-user;
an optical transmitter transmitting voice and data optical signals on a 1260-1360 mm band from the end-user and as second optical receiver for receiving a digital video signal on a 1550 mm wavelength from a video head-end service provider to the end-user; and
a wireless RF communication transmitter disposed in said housing and coupled to said electro-optic subassembly for wirelessly transferring the information content of said optical signal to an external device.

12. An optical network unit as defined in claim 10, wherein said RF communications transmitter is a wireless LAN transmitter using a communications protocol compliant with a protocol selected from the group consisting of (a) IEEE 802.11; (b)ultra wide band; and (c) wireless USB.

13. An optical network unit as defined in claim 10, wherein said external device is selected from the group including (a) video display; (b) a portable computer; and (c) a portable telephone handset.

14. An optical network unit as defined in claim 10, wherein said external device is an optical network unit as defined in claim 1, wherein said external device is selected from the group including (a) a video display; (b) a portable computer; (c) a portable telephone handset; and (d) a home security system.

15. An optical network unit as defined in claim 10, an optical network unit as defined in claim 1, further comprising a RF communications receiver disposed in said housing for wirelessly receiving control information from a user to select operational parameters for the wireless transfer of the information content to the external device.

16. A data communications system comprising:
(a) a passive optical network; and
(b) an optical network termination unit connected to said network including:
(i) a housing;
(ii) a first optical receiver disposed in said housing for receiving encoded voice and data optical signals on a 1480-1500 mm band;
(iii) an optical transmitter disposed in said housing transmitting voice and data optical signals on a 1260-1360 mm band from the end-user, and a second optical receiver for receiving a digital video signal on a 1550 mm wavelength band from a video head-end service provider to the end-user; and
(iv) a wireless RF communications transmitter disposed in said housing and coupled to said optical receiver for wirelessly transferring the information content of said optical signal to an external device.

16. An optical network unit as defined in claim 15, wherein said wireless RF communications transmitter is a wireless LAN access point.

17. An optical network unit as defined in claim 15, wherein said an optical network unit as defined in claim 1, wherein said optical signal is transmitted using a communications transport method or protocol selected from the group consisting of (a) IPTV; and (b) broadband RF; (c) SONET; (d) Gigabit Ethernet; (e) 10 Gigabit Ethernet; (f) Fibre Channel; and (g) SDH optical protocols.

18. An optical network unit as defined in claim 15, wherein said external device is a an optical network unit as defined in claim 1, wherein said external device is selected from the group (a) a video display; (b) a portable computer; (c) a portable telephone handset; and (d) a home security system.

19. An optical network unit as defined in claim 15, further comprising a RF communications receiver disposed in said housing for wirelessly receiving control information from a user to select operational parameters for the wireless transfer of the information content to the external device. An optical network unit as defined in claim 15, wherein said information content is streaming video data and said operational parameters are selected from a group including the compression level and display standard.

20. An optical network unit as defined in claim 15, wherein said video data is packetized as IP video.
